(19) United States
(12) Patent Application Publication
(10) Pub. No.: US 2008/0269026 A1
(43) Pub. Date: Oct. 30, 2008

(54) Compact Ankle Exerciser

(76) Inventor: Tsafrir Tsadok, Holon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/718,985

(22) PCT Filed: Nov. 10, 2005
(86) PCT No.: PCT/IL2005/001183

§ 371 Date: Mar. 20, 2008

(30) Foreign Application Priority Data
Nov. 10, 2004 (IL) 165146

(51) Int. Cl. A63B 23/08

(52) U.S. Cl. 482/79

(57) ABSTRACT

The ankle exerciser of the present invention may be configured to provide either dorsiflexion or plantar flexion movement or a combination of both by providing a footrest-cover that rocks alternately between a lowered “toes down” position and a raised “toes up” position. Substantially all of the components of the exerciser are enclosed in a base housing, the cover of which is also the rocking footrest.

### FIELD AND BACKGROUND OF THE INVENTION

The present invention relates to devices for therapeutic exercise to an ankle and, in particular, it concerns a compact ankle exerciser.

There are numerous physical therapy devices directed toward dorsiflexion and plantar flexion exercises of the ankle. Representative examples are disclosed in U.S. Pat. No. 3,318,304 to Gurewich, U.S. Pat. No. 3,370,584 to Girten and U.S. Pat. No. 6,758,825 to Mathew. The Gurewich device is designed for use in conjunction with a bed, while the Mathew device is considered to be portable.

Common to the vast majority of such devices, including all three of those mentioned above, is a substantially planar base upon which a motor is mounted and from which at least one hinged footrest extends. Generally, a rod extends from the motor to the footrest in order to actuate the desired rocking motion of the footrest on the hinge. Further, these devices are directed solely to dorsiflexion movement, and are not readily adaptable to plantar flexion movement or a simultaneous combination of both dorsiflexion and plantar flexion movements since their hinges are located at the edge of the footrest element of the device.

Although Mathew illustrates his device mounted on the footrest of a wheelchair, the placement of the motor above the plane of the wheelchair footrest provides a bulky device with the device footrest deployed at a steep angle such that the device is generally unsuited and impractical for such an application.

Furthermore, the devices of prior art are generally intended to be operated solely by professionals in the field of physical therapy, and little if any attention has been paid to safety issues such that motors and other operational parts are left exposed in such a way that appendages such as fingers and toes could be caught between moving parts of the device.

There is therefore a need for a compact ankle exerciser in which the operation components of the exerciser are substantially enclosed. It would be of benefit if the exerciser were configured such that the operational components are enclosed in a case, the cover of which also acted as the rocking exercise surface of the exerciser. It would be of further benefit if when the exerciser is deployed on the footrest of a wheelchair, the motor is at least partially below the level of the upper surface of the wheelchair footrest. It would also be of benefit if the movement actuating system of the exerciser can be adjusted to provide varying ranges of exercise motion.

### SUMMARY OF THE INVENTION

The present invention is a compact ankle exerciser.

According to the teachings of the present invention there is provided, a device for actuating movement of an ankle, the device comprising: (a) a base housing; (b) a footrest-cover rotatably attached to the base housing such that the footrest-cover acts as a cover for the base housing; and (c) an actuation system deployed in the base housing, the actuation system configured to rotate the footrest-cover relative to the base housing in a substantially pivotal rocking motion; wherein the base housing and the footrest-cover cooperate to substantially enclose the actuating system; the base housing, the footrest-cover and the actuating system being configured to define an axis of rotation of the substantially pivotal rocking motion.

According to a further teaching of the present invention, the axis is in the rear one third of the length of the footrest-cover.

According to a further teaching of the present invention, a range of motion of a front edge of the footrest-cover is between 0-10 cm, and a range of motion of a rear edge of the footrest-cover is between 0-5 cm.

According to a further teaching of the present invention, the footrest-cover includes a skirt that extends below a top surface of the footrest-cover.

According to a further teaching of the present invention, the skirt substantially encircles the base housing so as to overlap at least a portion of side walls of the base housing.

According to a further teaching of the present invention, a length of the skirt is such that the skirt substantially maintains the overlap during the pivotal rocking motion.

According to a further teaching of the present invention, the base housing further includes a wheelchair footrest attachment region configured for attaching the base housing to a wheelchair footrest.

According to a further teaching of the present invention, the wheelchair footrest attachment region includes a releasable attachment mechanism.

According to a further teaching of the present invention, the releasable attachment mechanism is configured as a screw device.

According to a further teaching of the present invention, the releasable attachment mechanism is configured as spring activated device.

According to a further teaching of the present invention, the wheelchair footrest attachment region is configured between front and rear support structures, the front and rear support structures being configured for supporting the base housing on a substantially horizontal surface.

According to a further teaching of the present invention, the actuating system is at least partially deployed in the front support structure.

According to a further teaching of the present invention, there is also provided at least one battery mounted within the base housing and delivering power to the actuating system.

According to a further teaching of the present invention, the footrest-cover includes a foot retaining rim.

According to a further teaching of the present invention, the actuating system includes an eccentric linkage that engages a slot in a downwardly projecting tab extending from the footrest-cover.

### BRIEF DESCRIPTION OF THE DRAWINGS

The invention is herein described, by way of example only, with reference to the accompanying drawings, wherein:

FIG. 1 is an isometric view of a first preferred embodiment of a foot exerciser constructed and operative according to the teachings of the present invention, shown here with the footrest-cover in substantially horizontal position;

FIG. 2 is a side elevation of FIG. 1;

FIG. 3 is an isometric view of the embodiment of FIG. 1, shown here with the footrest-cover in a toes raised position;

FIG. 4 is a side elevation of FIG. 3;

FIG. 5 is a top elevation of the embodiment of FIG. 1;

FIG. 6 is an isometric view of the base housing of the embodiment of FIG. 1 showing the interior of the housing;

FIG. 7 is a schematic isometric view an actuating system constructed and operative according to the teachings of the present invention;

FIG. 8 is a side elevation of FIG. 7;

FIG. 9 is a transparent isometric view of the base housing of FIG. 6 showing batteries deployed in the battery compartment;

FIG. 10 is an isometric view of the embodiment of FIG. 1 showing the bottom of the base housing and the battery compartment door;

FIG. 11 is an isometric view of a second preferred embodiment of a foot exerciser constructed and operative according to the teachings of the present invention, shown here with the footrest-cover in substantially horizontal position; and

FIG. 12 is an isometric view of the embodiment of FIG. 11, shown here with the footrest-cover in a toes raised position.

### DESCRIPTION OF THE PREFERRED EMBODIMENTS

The present invention is a compact ankle exerciser.

The principles and operation of a compact ankle exerciser according to the present invention may be better understood with reference to the drawings and the accompanying description.

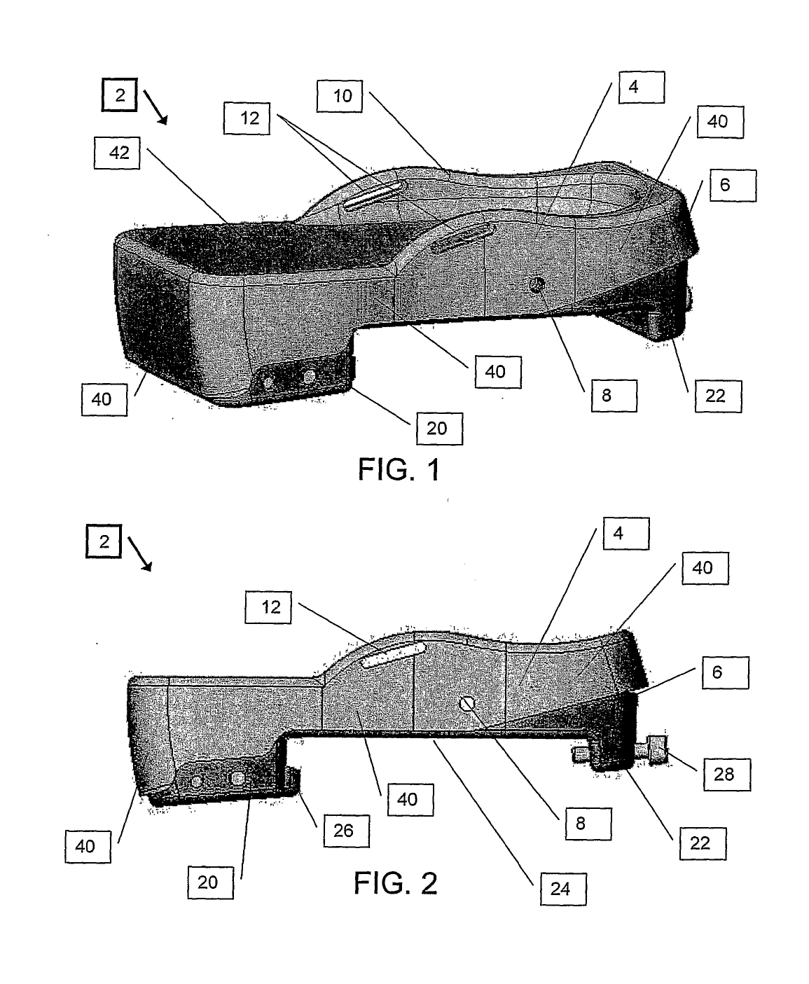

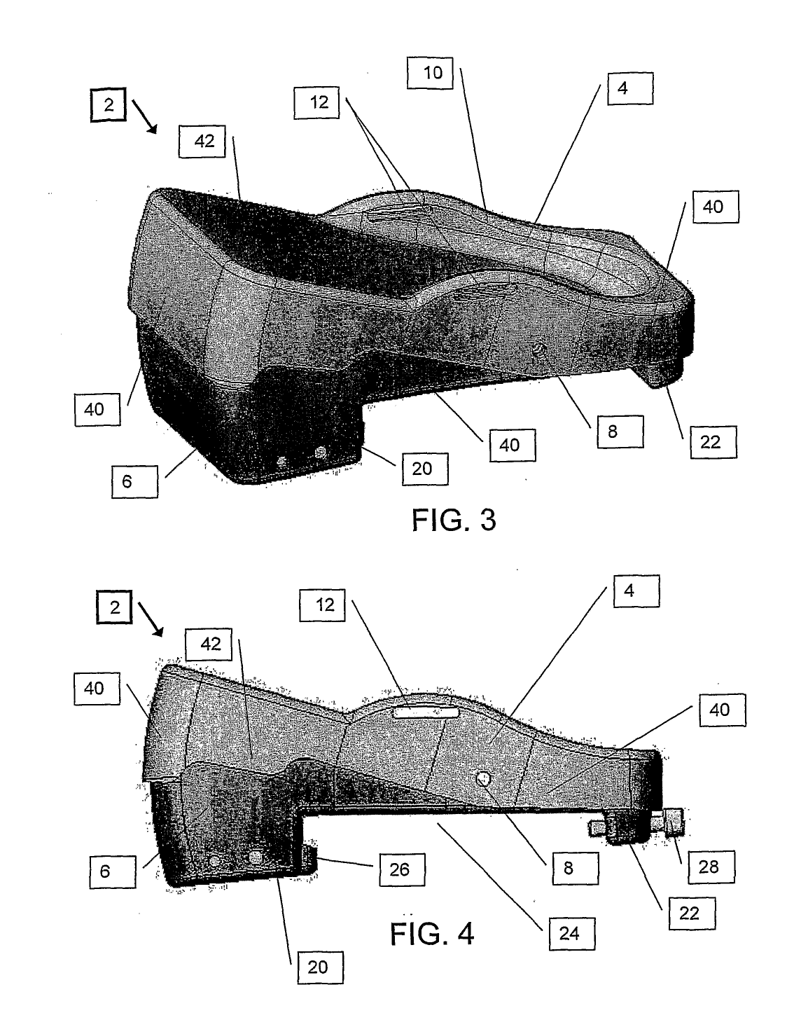

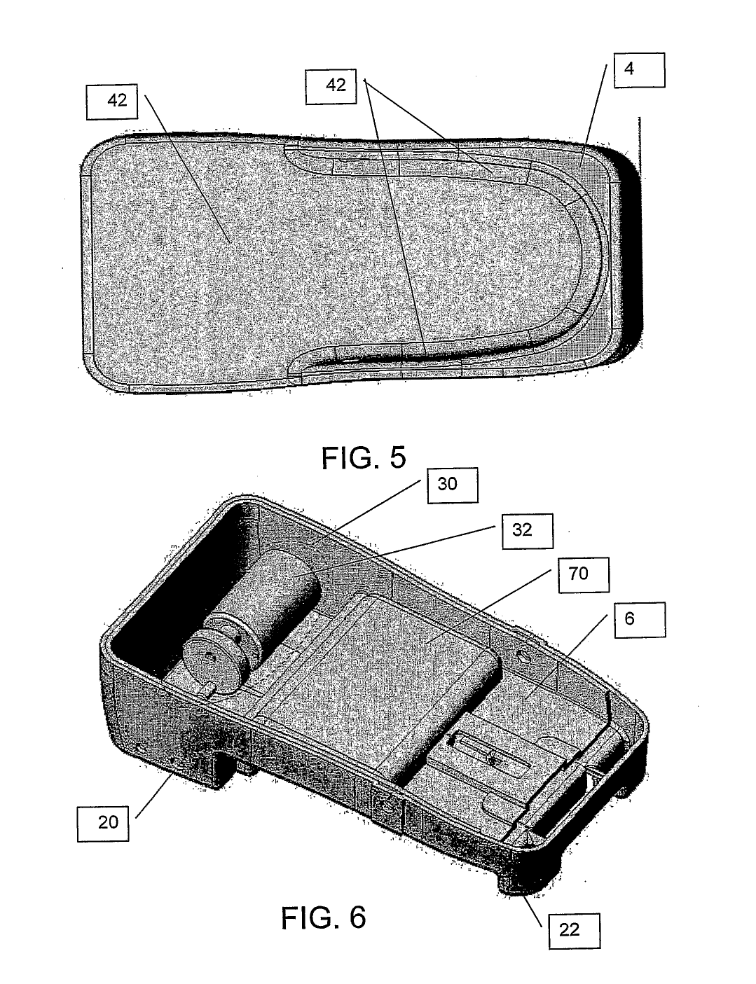

By way of introduction, the ankle exerciser of the present invention may be configured to provide either dorsiflexion or plantar flexion movement or a combination of both by providing a footrest-cover that rocks alternately between a substantially horizontal “toes down” position (FIG. 1) and a raised “toes up” position (FIG. 3). It should be noted that the use herein of the terms “horizontal” and “vertical”, is intended to refer to relative positions as illustrated herein and when the exerciser is deployed on a substantially horizontal surface.

The rocking motion of the footrest-cover generates dorsiflexion and plantar flexion movements of the foot that in turn creates movement in the calf muscles of the leg. The movement of the calf muscles facilitates blood flow in the leg by squeezing blood from the distal extremities in a proximal direction toward the heart. Stimulating such blood flow in individuals unable to do so in a normal fashion, such as walking, is helpful in the prevention of pathological conditions such as edema, deep vein thrombosis (DVT) and flow stagnation. The therapeutic preventative action of the present invention to enhance and support blood flow in the lower limbs may be of value to individuals confined to beds and wheelchairs, and those who must sit for long periods of time such as during a long airplane flight, and work related activities that require sitting.

The exerciser of the present invention is portable and may be used in a variety of situations such as, but not limited to, wheelchair footrests, and on the floor at home and at the office. When configured to be battery operated, the exerciser may be used while traveling such as, but not limited to, by auto, bus, boat, train and plane. The exerciser may also be supported on a non-horizontal surface and may even used with bed ridden patients. The exerciser of the present invention may be used by healthcare professionals and non-professionals as well as private individuals, as part of a therapeutic regimen or for personal use.

Substantially all of the components of the exerciser are enclosed in a base housing, the cover of which is also the rocking footrest. In the preferred embodiments illustrated herein, the footrest-cover includes skirting encircling the base housing to protect from the possibility of objects such as patient appendages getting between any moving parts of the exerciser.

The modular configuration of the movement actuating system provides for interchangeable eccentric actuators that produce a variety of ranges of motion. Further, the use of a variable speed motor and a gear reduction system provide a range of rotational speeds delivered to the footrest-cover that includes speeds of less than 10 revolutions per minute, with a preferred rate of 4-5 RPM. That is to say, the rocking rate of the footrest-cover may be adjustable to less than 10 RPM, and preferably 4-5 RPM.

The ankle exerciser of the present invention may be configured for use with one or both feet of the patient. The exerciser may be attached to the footrest of a wheelchair or placed on substantially any surface, and is operable at substantially any angle.

Optionally, the exerciser may include a sensing system configure to determine of a foot is present on the footrest-cover. The sensing system may be configured using any one or combination of sensors including, but not limited to, micro switches, optical sensors, and proximity sensors.

Referring now to the drawings, FIGS. 1 and 2 illustrate a first preferred embodiment of the ankle exerciser of the present invention, generally referred to herein by the numeral 2, with the footrest-cover in a substantially horizontal “toes down” position.

The footrest-cover 4 rotates, that is “rocks”, relative to the base housing 6 about axle 8. The footrest-cover 4 is preferably configured with a foot retaining rim 10 that encloses at least the heel portion of the footrest-cover and may extend along the either one or both of the sides of the foot area as is illustrated here. There may also be provided slots 12 for the attachment of foot straps, thereby providing added foot retention support.

The base housing 6 is configured with a front floor support 20 and rear floor support 22. Configured between the two floor supports is the wheelchair footrest attachment region 24. The front floor support 20 includes a lip, or lips, 26 that extends into the wheelchair footrest attachment region 24 such that, when deployed on the footrest of a wheelchair, the lip 26 fits under the wheelchair footrest. The rear floor support 22 includes a releasable attachment mechanism 28 configured to exert pressure against the wheelchair footrest, thereby securing the ankle exerciser 2 on the wheelchair footrest. It should be noted that the releasable attachment mechanism 28 may be configured, by non-limiting example, as a screw device or a spring tension device. Such a spring tension device may be configured as a bar biased toward the wheelchair footrest attachment region 24 by a spring. Further, the lip 26 may be configured in the rear floor support 22 and the releasable attachment mechanism 28 may be configured in the front floor support 20. Such a configuration provides for use of the exerciser on either the footrest of a wheelchair of the floor. It should be noted that the bottom surfaces of front floor support 20 and rear floor support 22 may be fitted with non-skid materials to provide added support when the exerciser is used on the floor or ground.

FIGS. 3 and 4 help to illustrate the utility of the skirt 40 that extends below the top surface 42 of the footrest-cover 4 and that encircles the much of the base housing 6. The skirt 40 substantially fills any gaps that may be formed between the footrest-cover 4 and the base housing 6 during operation of the exerciser 2. During operation, the forward edge of the footrest-cover of the embodiment illustrated herein raises about 55 mm and the rear edge raises about 30 mm. The length of the skirt is sufficiently long that the base housing remains substantially closed through the range of motion of the footrest-cover. The phrase “substantially closed” is used herein allows for a small opening to occur at the end of the range of motion of the footrest-cover, however, the opening is too small to allow insertion of any appendage, such as a finger. It should be noted that the bottom edge of the skirt is configured so as not to contact any underlying surfaces, such as a wheelchair footrest, that may interfere with the rocking motion of the footrest-cover during operation.

As illustrated in FIG. 6, the actuating system 30, which includes motor 32, is located in the front portion of the base housing in the front floor support 20. The base housing is therefore configured to allow the motor 32 and other actuating system elements to be at least partially deployed below the top surface of a wheelchair footrest when the exerciser 2 is so deployed. The motor 32 is preferably a DC gear motor.

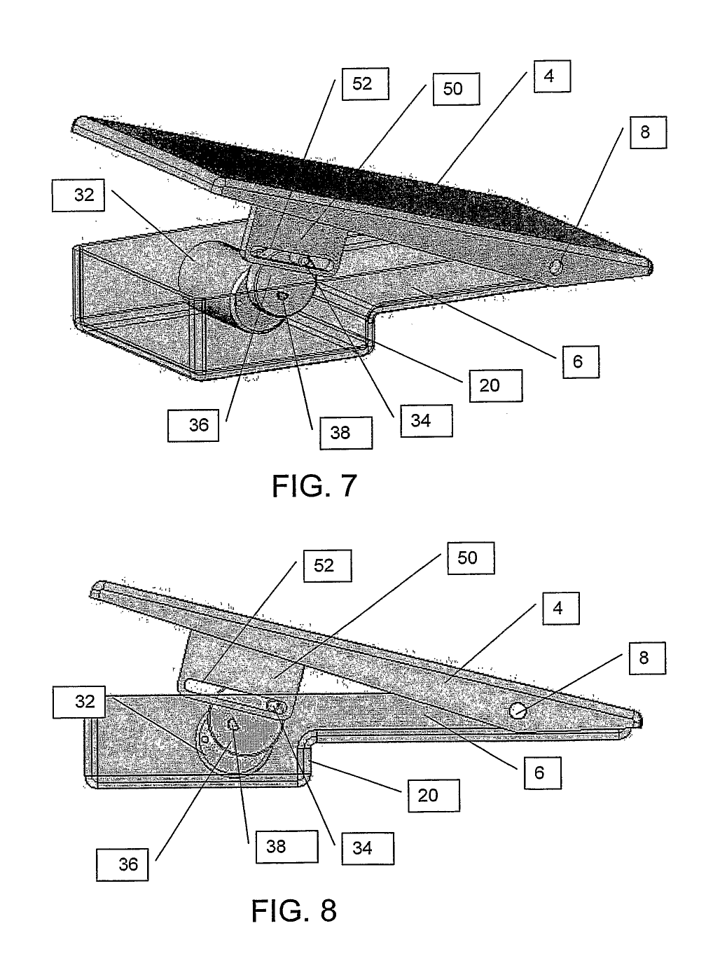

FIGS. 7 and 8 schematically illustrate a preferred actuating system according to the present invention. It will be appreciated that the non-limiting example herein described is only one of numerous ways in which to generate the rocking motion of the footrest-cover. Footrest-cover 4 is configured with a tab 50 extending downwardly into the interior region of the front floor support 20 of base housing 6. Tab 50 includes a slot 52 that engages stud 34 which extends from the actuating wheel 36. The actuating wheel 36 is eccentrically mounted on the axle 38 of motor 32. The rotation of the actuating wheel 36 causes the front on the footrest-cover 4 to rise and lower, thereby generating the required rocking motion. The height of the footrest-cover and the distance it travels are determined, at least in part, by the distance between stud 34 and axle 38, and the eccentricity of actuating wheel 36 on axle 38. Therefore, actuating wheel 36 may be configured with a plurality of holes enabling varied deployment of stud 34 on wheel 36, and of wheel 36 on axle 38. Alternately, the actuating system may include a variety of interchangeable actuating wheels, each configured with differing degrees of eccentricity and stud placement.

It will be readily understood that the placement of axle 8 is directly related to the amount of dorsiflexion and/or plantar flexion movement generated by the rocking motion of the footrest-cover 4. In the embodiment illustrated in FIG. 1, the front of the footrest-cover 4 travels a distance up and down of about 55 mm, and the rear of the footrest-cover travels a distance up and down of about 30 mm. It will be readily appreciated that placement of axle 8 farther to the rear will increase the upward motion of the front edge of the footrest-cover 4 and decrease the upward motion of the rear edge. Placement of axle 8 near the center of the length of the footrest-cover may result in substantially equal displacement of the front and rear edges of the footrest-cover 4. Due to the adjustability of both the actuating system and the axle placement of the footrest-cover 4, the full range of motion possible for the front edge of the footrest-cover is between 0-10 cm. The full range of motion possible for the rear edge of the footrest-cover 4 is between 0-5 cm. The maximum angle of rotation of the footrest-cover 4 about axle 8 as illustrated herein, is about 18 degree. It will be appreciated that the maximum angle of rotation may vary depending on the placement of the axle.

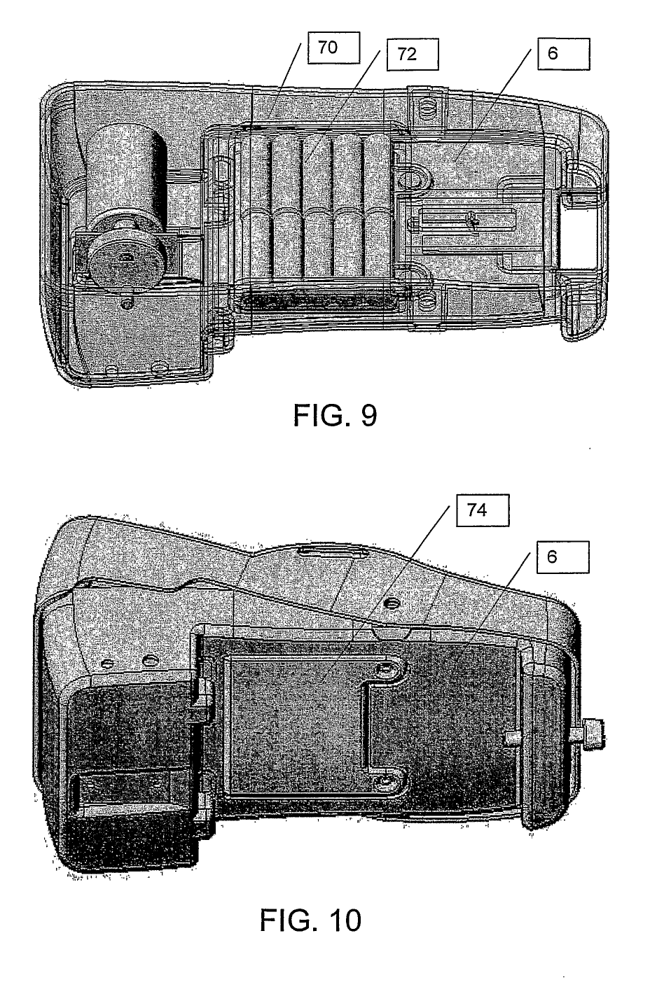

FIG. 9 provides a transparent view of the base housing 6, and in particular illustrates batteries 72 deployed in the battery compartment 70 configured in the base housing 6. The battery compartment 70 is accessible through the battery compartment door 74 located in the bottom surface of the base housing 6, as seen in FIG. 10. Batteries 72 may be rechargeable batteries and an outlet may be provided in the base housing 6 for connection to a battery charger.

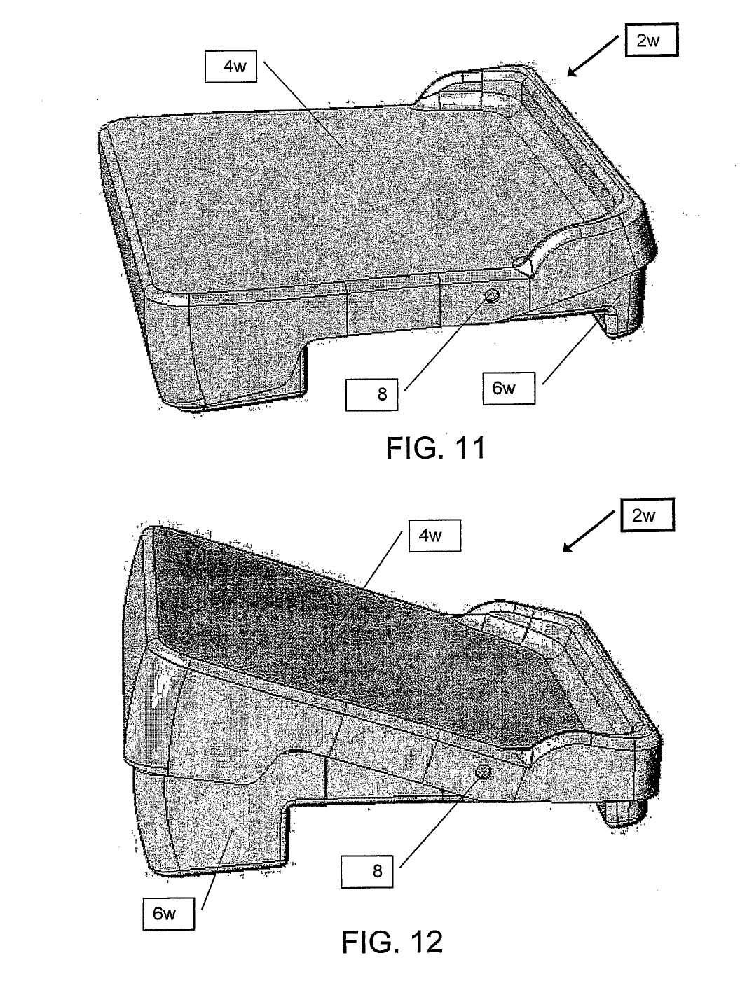

FIGS. 11 and 12 illustrate a wider second preferred embodiment 2w of the ankle exerciser of the present invention that is configured for use with two feet. This embodiment includes a base housing 8w and footrest-cover 4w that rocks on axle 8. Operation is substantially the same as described above, and this wider embodiment may also be deployed on a wheelchair footrest or the floor.

It will be appreciated that the above descriptions are intended only to serve as examples and that many other embodiments are possible within the spirit and the scope of the present invention.

What is claimed is:

1. A device for actuating movement of an ankle, the device comprising:
(a) a base housing;
(b) a footrest-cover rotatably attached to said base housing such that said footrest-cover acts as a cover for said base housing; and
(c) an actuation system deployed in said base housing, said actuation system configured to rotate said footrest-cover relative to said base housing in a substantially pivotal rocking motion;
wherein said base housing and said footrest-cover cooperate to substantially enclose said actuating system; said base housing, said footrest-cover and said actuating system being configured to define an axis of rotation of said substantially pivotal rocking motion.

2. The device of claim 1, wherein said axis is in the rear one third of the length of the footrest-cover.

3. The device of claim 2, wherein a range of motion of a front edge of said footrest-cover is between 0-10 cm, and a range of motion of a rear edge of the footrest-cover is between 0-5 cm.

4. The device of claim 1, wherein said footrest-cover includes a skirt that extends below a top surface of said footrest-cover.

5. The device of claim 4, wherein said skirt substantially encircles said base housing so as to overlap at least a portion of side walls of said base housing.

6. The device of claim 5, wherein a length of said skirt is such that said skirt substantially maintains said overlap during said pivotal rocking motion.

7. The device of claim 1, wherein said base housing further includes a wheelchair footrest attachment region configured for attaching said base housing to a wheelchair footrest.

8. The device of claim 7, wherein said wheelchair footrest attachment region includes a releasable attachment mechanism.

9. The device of claim 8, wherein said releasable attachment mechanism is configured as a screw device.

10. The device of claim 8, wherein said releasable attachment mechanism is configured as spring activated device.

11. The device of claim 7, wherein said wheelchair footrest attachment region is configured between front and rear support structures, said front and rear support structures being configured for supporting said base housing on a substantially horizontal surface.

12. The device of claim 11, wherein said actuating system is at least partially deployed in said front support structure.

13. The device of claim 1, further comprising at least one battery mounted within said base housing and delivering power to said actuating system.

14. The device of claim 1, wherein said footrest-cover includes a foot retaining rim.

15. The device of claim 1, wherein said actuating system includes an eccentric linkage that engages a slot in a downwardly projecting tab extending from said footrest-cover.
